(19) United States
(12) Patent Application Publication
(10) Pub. No.: US 2013/0088362 A1
(43) Pub. Date: Apr. 11, 2013

(54) INTELLIGENT WELLHEAD RUNNING SYSTEM AND RUNNING TOOL

(71) Applicant: Vetco Gray Inc., Houston, TX (US)

(72) Inventors: Chad Eric Yates, Houston, TX (US); Dale Norman, Spring, TX (US)

(73) Assignee: VETCO GRAY INC., Houston, TX (US)

(21) Appl. No.: 13/679,789

(22) Filed: Nov. 16, 2012

Related U.S. Application Data
(63) Continuation-in-part of application No. 13/248,813, filed on Sep. 29, 2011.

(51) Int. Cl. G01V 3/00

(52) U.S. Cl. CPC G01V 3/00
USPC 340/854.3

(57) ABSTRACT

Systems and methods communicating between a subsea running tool disposed within a subsea wellhead, a blowout preventer assembly, and/or a subsea tree, and a surface platform are provided. An example of such a system includes a running tool assembly. The running tool assembly can include a running tool and a running tool wireless interface carried by the running tool. Wireless interface is configured to communicate running tool sensor data to a blowout preventer assembly wireless interface through a fluid medium located between the running tool wireless interface and a blowout preventer assembly wireless interface when the running tool is operably positioned within a bore extending through a component of the blowout preventer assembly or a bore extending through the subsea wellhead. The wireless communications scheme for communicating with a sensor data can include radiofrequency communications through the fluid medium between antenna components thereof, mutual inductive coupling, backscatter coupling, and/or capacitive coupling.

### BACKGROUND OF THE INVENTION

1. Related Applications

This application is a continuation-in-part of and claims priority to and the benefit of U.S. patent Ser. No. 13/248,813, filed on Sep. 29, 2011, incorporated by reference in its entirety.

2. Field of the Invention

This invention relates in general to subsea running tools and, in particular, systems and methods that provide remote communications from a subsea running tool to a surface platform through subsea equipment in communication with the surface platform.

3. Description of Related Art

Subsea running tools are used to operate equipment within subsea wellheads and subsea christmas trees. This may include landing and setting of hangers, trees, wear bushings, logging tools, etc. Current running tools may be hydraulically or mechanically operated. For example, a running tool may be run to a subsea wellhead to land and set a casing hanger and associated casing string. A mechanical running tool will land and set the casing hanger within the wellhead by landing on a shoulder and undergoing a series of rotations using the weight of the casing string to engage dogs or seals of the casing hanger with the wellhead. A hydraulic running tool may land and set the casing hanger by landing the hanger on a shoulder in the wellhead, and then use drop balls or darts to block off portions of the tool. Hydraulic pressure will build up behind the ball or dart causing a function of the tool to operate to engage locking dogs of the hanger or set a seal between the hanger and wellhead. Pressure behind the ball or dart can then be increased further to cause the ball or dart to release for subsequent operations. Some tools may be combination mechanical and hydraulic tools and perform operations using both mechanical functions and hydraulically powered functions. These tools are extremely complex and require complex and expensive mechanisms to operate. These mechanisms are prone to malfunction due to errors in both design and manufacturing. As a result, the tools may fail at rates higher than desired when used to drill, complete, or produce a subsea well. Failure of the tool means the tool must be pulled from and rerun into a well, adding several days and millions of dollars to a job.

Further, complicating matters are production running tools that require a hydraulic umbilical to be run with the running tool to power a hydraulic operation. These tools require the use of expensive equipment and additional time to run the umbilical within the riser and production or landing string. In addition, the umbilical requires significant facilities on the top side of the rig. This requires mobilizing specialized equipment and support personnel which add to the logistical challenges of completing a subsea well.

Another issue is that these tools provide limited feedback to operators located on the rig. For example, limited feedback directed to the torque applied, the tension of the landing string, and the displacement of the tool based on sensors on the surface equipment may be communicated to the rig operator. When a malfunction occurs, it is not until the string is retrieved, taking several hours and at the cost of thousands of dollars, and the tool is inspected, that the rig operator will know the extent of the malfunction and/or how the malfunction occurred. Also, even if there was no malfunction, rig operators generally do not have definitive confirmation that the running tool has operated as intended at the subsea location until the running tool is retrieved and inspected. A pressure test can often be passed even if the equipment has not been installed per the specification.

Further, it is recognized that as a running tool transverses the length of the riser between the surface location and the wellhead, the running tool is in a unique position to record both internal and external conditions encountered by the tool.

Accordingly, recognized by the inventors is the need for a running tool communication system including a running tool configured to interface with one or more blowout preventer assembly communication members, themselves connected to or interfaced with the subsea well and having access to subsea-surface equipment communication network, to provide real-time feedback to the rig operator. Further, recognized is the need for subsea communication system including a running tool configured to receive real-time instructions from the rig operator through the subsea wellhead-surface equipment communication network, particularly when a problem is encountered.

### SUMMARY OF THE INVENTION

In view of the foregoing, various embodiments of the present invention advantageously provide a running tool subsea communication system including a running tool configured to interface with one or more blowout preventer assembly communication components, themselves connected to or interfaced with the subsea well and having access to subsea-surface equipment communication network. Such embodiment or embodiments can advantageously provide real-time feedback to the rig operator regarding the status of the running tool and/or whether or not the running tool functioned properly during engagement with the wellhead. Various embodiments of the present invention also advantageously provide a subsea communication system including a subsea wellhead equipment component configured to receive from the rig operator via the subsea-surface equipment communication network, and to transmit real-time running tool instructions, and a running tool configured to receive and act upon such instructions. Such embodiment or embodiments can advantageously provide such remote communications, particularly when a problem is encountered, in order to attempt correction rather than having to retrieve and rerun the running tool.

More specifically, an embodiment of the present invention includes a running tool subsea communication system for communicating between a subsea running tool assembly disposed within a subsea wellhead, a blowout preventer assembly, or a combination thereof, and a surface platform. The running tool assembly includes a running tool adapted to be suspended within a subsea wellhead, and/or a blowout preventer assembly, on or by a running string lowered from a surface platform. The running tool assembly also includes a running tool wireless interface carried by the running tool and configured to communicate with a blowout preventer assembly wireless interface through a fluid medium located between the running tool wireless interface and the blowout preventer assembly wireless interface. The communications are generally relatively short range due to transmission power limitations and attenuation due to the nature of the fluid medium, and thus, generally are designed to occur when the running tool is operably positioned within the axial bore of a member of the blowout preventer assembly or a bore extending through the subsea wellhead and when the running tool wireless interface is at a location within the relatively short communication range with the blowout preventer assembly wireless interface. Beneficially, the running tool wireless interface provides running tool sensor data to the blowout preventer assembly wireless interface, which can be forwarded to the surface operator via the subsea electronic module communication network.

According to another embodiment of the running tool subsea communication system, the system can include a blowout preventer assembly disposed on a subsea wellhead, a wireless interface carried by one or more members of the blowout preventer assembly and configured to provide running tool sensor data to a subsea electronics module, a running tool adapted to be suspended within the subsea wellhead and/or one or more members of the blowout preventer assembly, or a combination thereof, on or by a running string lowered from a surface platform; and a running tool wireless interface carried by the running tool. The running to wireless interface is configured to communicate with the blowout preventer assembly wireless interface through a fluid medium located between the running tool wireless interface and the blowout preventer assembly wireless interface when the running tool is operably positioned within an axial bore extending through one of the members of the blowout preventer assembly or an axial bore extending through the subsea wellhead and when the running tool wireless interface is at a location within communication range with the blowout preventer assembly wireless interface to thereby provide running tool sensor data to the subsea electronics module. Beneficially, there are several communication schemes available for transferring the running tool sensor data to the surface operator and/or receiving control instructions from the surface operator. These include radiofrequency communications through the fluid medium between antenna components of the running tool and blowout preventer assembly wireless interfaces, mutual inductive coupling, backscatter coupling, and capacitive coupling.

Methods for communicating between a surface platform and a subsea running tool disposed within a subsea wellhead, a blowout preventer assembly, or a combination thereof, are also provided. An example of such a method can include the steps of providing a running tool wireless interface carried by a running tool, providing a blowout preventer assembly wireless interface mounted to a member of a blowout preventer assembly or mounted to a subsea wellhead connected with the blowout preventer assembly, positioning the running tool within an axial bore of one or more members of the blowout preventer assembly, an axial bore of the subsea wellhead, or a combination thereof, and communicating running tool sensor data to the blowout preventer assembly wireless interface through a fluid medium located between the running tool wireless interface and the blowout preventer assembly wireless interface.

The steps can also include providing the running tool having one or more running tool sensors positioned on the running tool. The running tool sensor or sensors can include an azimuth sensor that provides a rotational azimuth of the running tool, a hydraulic function positive indicator sensor, a wellhead seal engagement pressure sensor, and/or a dog extension sensor. The steps can correspondingly include determining running tool angular position, determining running tool alignment with respect to the wellhead, determining running tool hydraulic operation status, determining running tool setting loads imparted on a wellhead seal, and/or determining proper running tool dog engagement.

According to another embodiment, the steps can include providing a running tool having one or more running tool engagement sensors positioned on the running tool, determining the running tool's engagement status, and providing the running tool engagement data to the blowout preventer assembly wireless interface. The running tool engagement status can include running tool rotational position, running tool alignment with respect to the wellhead, running tool hydraulic operation status, running tool setting loads imparted on a wellhead seal, and/or running tool dog engagement status.

In a specific configuration, the running tool has a hydraulic accumulator mounted to the running tool and at least one hydraulic valve mounted to the running tool to control fluid pressure between the hydraulic accumulator and a hydraulic function of the running tool. In this configuration, the blowout preventer wireless interface is communicatively coupled to a subsea electronics module communicatively coupled to an umbilical extending to a surface platform, and the one or more tool engagement sensors includes a positive hydraulic function indicator sensor that provides data indicating operation of the hydraulic function of the running tool to a running tool controller. In this configuration, the steps also include providing actuation commands to the at least one hydraulic valve to provide hydraulic pressure to the hydraulic function of the running tool responsive to control instructions provided by a platform operator and relayed through the subsea electronic module, blowout preventer wireless interface, and one or more components of the running tool wireless interface, to the running tool controller.

In another embodiment, the running tool assembly includes an azimuth sensor that provides a rotational position of the running tool. In this embodiment, the step of communicating running tool sensor data to the blowout preventer assembly wireless interface includes communicating the rotational position of the running tool to the blowout preventer assembly wireless interface. Correspondingly, the steps can also include communicating the rotational position of the running tool to a surface platform operator control or monitoring unit through utilization of a subsea control module communicatively coupled to an umbilical extending to the surface platform.

According to various embodiments, the running tool wireless interface is configured to communicate the running tool sensor data to the blowout preventer wireless interface via RF communications through the fluid medium between antenna components thereof, mutual inductive coupling, backscatter coupling, and capacitive coupling.

When configured for RF communications, the running tool wireless interface can include a running tool-mounted radiofrequency (RF) antenna positioned in contact with the fluid medium surrounding the running tool and the blowout preventer assembly wireless interface can include a blowout preventer member-mounted RF antenna positioned in contact with the fluid medium adjacent thereto. In such configuration, the step of communicating running tool sensor data can include transmitting a data signal between the running tool-mounted RF antenna and the blowout preventer assembly member-mounted RF antenna through the fluid medium located therebetween.

When configured for near-field or inductive coupling communication, the running tool wireless interface can include a running tool-mounted induction loop positioned in contact with the fluid medium surrounding the running tool and the blowout preventer assembly wireless interface can include a blowout preventer assembly member-mounted induction loop positioned in contact with the fluid medium adjacent thereto. In such configuration, the step of communicating running tool sensor data can include positioning the running tool so that the running tool-mounted induction loop is axially positioned adjacent the blowout preventer assembly member-mounted induction loop, and inductively coupling the blowout preventer assembly member-mounted induction loop with the running tool-mounted induction loop when the running tool-mounted induction loop is axially adjacent the blowout preventer assembly member-mounted induction loop to provide the running tool sensor data to the blowout preventer assembly wireless interface.

When configured for far-field or backscatter coupling communication, the running tool wireless interface can include a running tool-mounted antenna positioned in contact with the fluid medium surrounding the running tool and the blowout preventer assembly wireless interface can include a blowout preventer assembly member-mounted antenna positioned in contact with the fluid medium adjacent thereto. In such configuration, the step of communicating running tool sensor data can include reflecting, by the running tool wireless interface, a signal provided by the blowout preventer assembly wireless interface performed through the fluid medium between the running tool-mounted antenna and the blowout preventer assembly member-mounted antenna.

When configured for capacitive coupling communication, the running tool wireless interface can include a running tool-mounted electrode positioned in contact with the fluid medium surrounding the running tool and the blowout preventer assembly wireless interface can include a blowout preventer assembly member-mounted electrode positioned in contact with the fluid medium adjacent thereto. In such configuration, the step of communicating running tool sensor data can include positioning the running tool so that the running tool-mounted electrode is axially positioned adjacent the blowout preventer assembly member-mounted electrode, and capacitively coupling the blowout preventer-mounted electrode with the running tool-mounted electrode when the running tool-mounted electrode is axially adjacent the blowout preventer-mounted electrode, forming an electric field therebetween to provide the running tool sensor data to the blowout preventer assembly wireless interface through the fluid medium between the respective electrodes.

### BRIEF DESCRIPTION OF THE DRAWINGS

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 is a schematic representation of a subsea system according to an embodiment of the present invention.

FIG. 2 is a schematic representation of a blowout preventer assembly including a generic wireless BOP assembly interface according to an embodiment of the present invention, shown without a blowout preventer frame.

FIG. 3 is a schematic representation of a running tool assembly including a generic running tool assembly wireless interface according to an embodiment of the present invention shown without a blowout preventer frame.

FIG. 4A is a schematic representation of a running tool assembly including a running tool wireless interface configured to provide RF communications according to an embodiment of the present invention.

FIG. 4B is a schematic representation of a blowout preventer assembly including a blowout preventer wireless interface configured to receive and demodulate RF communications according to an embodiment of the present invention.

FIG. 4C is a schematic representation of the running tool wireless interface of the running tool assembly of FIG. 4A in RF communications with the blowout preventer wireless interface of the blowout preventer assembly of FIG. 4B according to an embodiment of the present invention.

FIG. 5A is a schematic representation of a running tool including a running tool wireless interface configured to provide for inductive coupling according to an embodiment of the present invention.

FIG. 5B is a schematic representation of a blowout preventer assembly including a blowout preventer wireless interface configured to receive and demodulate data provided through inductive coupling according to an embodiment of the present invention.

FIG. 5C is a schematic representation of the running tool wireless interface of the running tool assembly of FIG. 5A in the near field communications (inductive coupling) with the blowout preventer wireless interface of the blowout preventer assembly of FIG. 5B according to an embodiment of the present invention.

FIG. 6A is a schematic representation of a running tool including a running tool wireless interface configured to provide for backscatter coupling according to an embodiment of the present invention.

FIG. 6B is a schematic representation of a blowout preventer assembly including a blowout preventer wireless interface configured to provide radiowave transmissions and to demodulate a modulated backscatter signal according to an embodiment of the present invention.

FIG. 6C is a schematic representation of the running tool wireless interface of the running tool assembly of FIG. 6A in far field (back scatter) communications with the blowout preventer wireless interface of the blowout preventer assembly of FIG. 6B according to an embodiment of the present invention.

FIG. 7A is a schematic representation of a running tool including a running tool wireless interface configured to provide for capacitive coupling according to an embodiment of the present invention.

FIG. 7B is a schematic representation of a blowout preventer assembly including a blowout preventer wireless interface configured to provide capacitively coupled transmissions and to receive a modulated data signal according to an embodiment of the present invention.

FIG. 7C is a schematic representation of the running tool wireless interface of the running tool assembly of FIG. 7A in capacitive communications with the blowout preventer wireless interface of the blowout preventer assembly of FIG. 7B according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. Prime notation, if used, indicates similar elements in alternative embodiments.

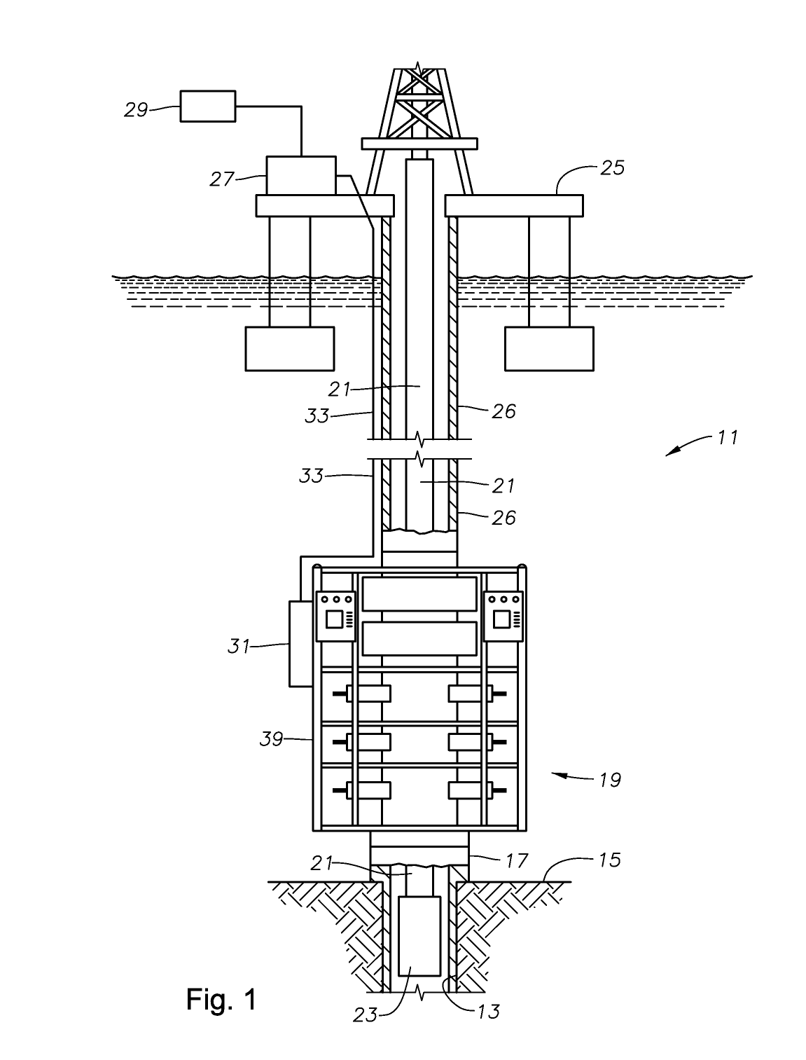

FIG. 1 illustrates a subsea assembly 11 including a wellbore 13 located at a seafloor 15, and a subsea wellhead 17 position at an upper end of wellbore 13. The wellhead 17 may include both a wellhead and a subsea tree. A blowout preventer (BOP) assembly (stack) 19 is disposed on the wellhead 17. A running string 21 used to run a subsea running tool 23 is shown suspended in/through a riser 26, the wellbore 13, and/or a bore extending through the wellhead 17. The running string 21 extends from the platform 25 located at a sea surface to the subsea running tool 23. The platform 25 may be a drilling rig that may conduct various operations to drill and complete a subsea well. The subsea riser 26 generally extends between the BOP assembly 19 and the platform 25. Other intermediate components as known to those of ordinary skill in the art, however, may be connected therebetween.

A central control unit (CCU) 27 is positioned on platform 25 and is communicatively coupled to a driller's control panel 29, a tool pusher's control panel, or other surface communication equipment. CCU 27 is further communicatively coupled to a subsea electronics module (SEM) 31, for example, located on a frame of BOP assembly 19, by a communication umbilical 33 that extends on an exterior of subsea riser 26 to BOP assembly 19 to platform 25. An umbilical reel (not shown) may be used to run communication umbilical 33 with running string 21 during running operations of subsea assembly 11. Note, one of ordinary skill in the art would recognize that the SEM 31 can be positioned/connected at other locations. One of ordinary skill in the art would also recognize that the subsea well-to-surface communication can be through other means including various forms of wireless communication to include radiofrequency (RF) and/or acoustic.

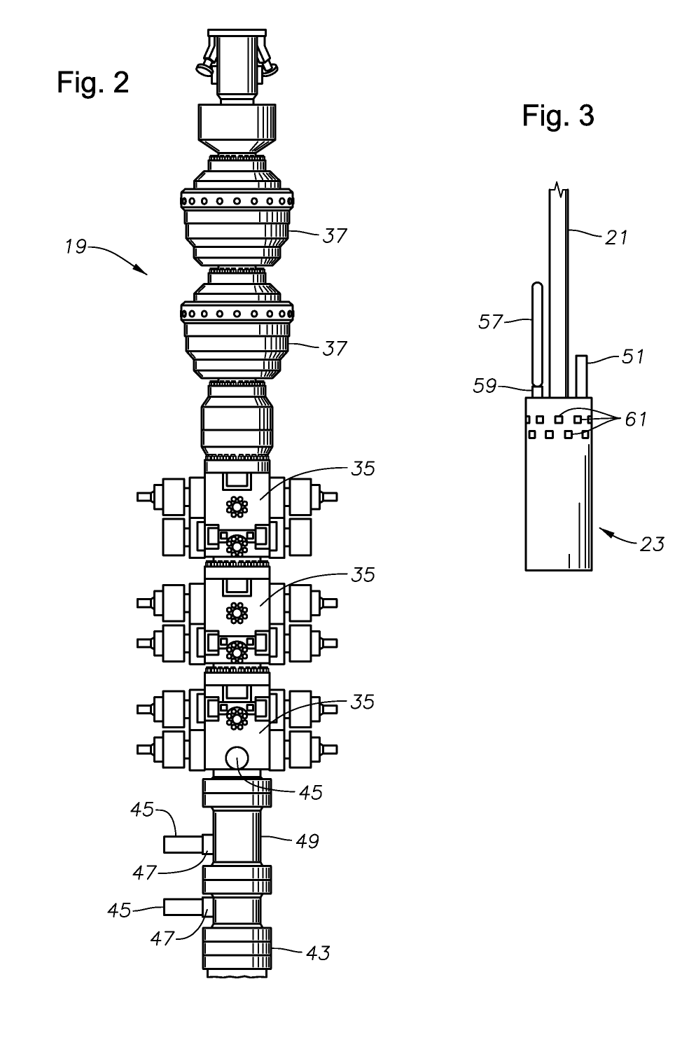

Referring to FIG. 2, a typical BOP assembly 19 includes at least one shear ram assembly 35, three of which are shown, and at least one annular BOP assembly 37, two of which are shown. The BOP assembly 19 includes a BOP assembly frame 39 that is mounted around the BOP assembly 19. The BOP assembly frame 39 provides a mounting position for the SEM 31 (FIG. 1), as well as additional equipment such as hydraulic accumulators, and the like. Hydraulic accumulators may provide hydraulic power for some subsea hydraulic components such as shear assemblies 35. An operator may send signals from platform 25 through communication umbilical 33 to the SEM 31. The signals may be operation signals that instruct shear assemblies 35, BOPs 37, and/or other subsea operations to operate.

The BOP assembly 19 also includes a subsea wellhead connector 43 and at least one wireless interface 45, three of which are shown, individually referred to as BOP assembly wireless interface 45. The subsea wellhead connector 43 mounts to subsea wellhead 13. The BOP assembly wireless interface or interfaces 45 may be mounted in any of the three positions shown in the figure, as well as others as would be known and understood by one of ordinary skill in the art. In the first position, a wireless interface 45 mounts to the wellhead connector 43 through an attachment fitting/connector 47. In the second position, a wireless interface 45 also or alternatively mounts through attachment fitting/connector 47 in a separate tubular member 49 positioned between wellhead connector 43 and the first shear assembly 35. In the third position, a wireless interface 45 also or alternatively mounts within a ram cavity of the first shear assembly 35. A person skilled in the art will understand that any of the three mounting positions shown may be used independently of the other two and are shown together for illustrative purposes only.

Note, the following described embodiments are primarily directed to use of a single electromagnetic-based wireless interface 45 mounted to the BOP assembly 19, although alternative embodiments may include mounting of more than one BOP assembly wireless interface 45 to BOP assembly 19 as shown, for example, in FIG. 2. These alternative embodiments are contemplated and included in the disclosed embodiments. In each mounting position, the respective BOP assembly wireless interface 45 is in communication with the fluid in the bore or bores extending through the BOP assembly 19 surrounding running tool 23 (FIG. 3). Further, each of the one or more wireless interfaces 45 can be a similar configuration and/or provide different types of configurations to support different running tool configurations.

Each BOP assembly wireless interface 45 may be communicatively coupled to the SEM 31 (FIG. 1). In an embodiment, this is done through an electrical cable (not shown) mounted to BOP assembly frame 39 that extends from the mounting location of BOP assembly wireless interface 45 to SEM 31. Although not shown in FIG. 2, running string 21 and running tool 23 will be suspended within BOP assembly 19 so that running tool 23 may interact with subsea wellhead 17. Note, portions of interface 45 can be incorporated in one or more modules of the SEM 31 or provided as stand-alone units electrically/optically connected to the SEM 31.

Referring to FIG. 3, running tool 23 is shown suspended by/on running string 21. Running tool 23 can be in the form of a tubing hanger running tool, an internal tree cap running tool, a pressure test tool, a casing hanger running tool, a lead impression tool, a seal retrieval tool, or others as known to those of ordinary skill in the art. The running tool 23 includes a running tool wireless interface 51 shown generically in FIG. 3. Running tool 23 may also include hydraulic accumulators 57 and hydraulic valves 59. Still further, running tool 23 may include a plurality of sensors 61.

The running tool wireless interface 51 is in communication with the fluid in the BOP assembly 19. Thus, depending on the embodiment, running tool wireless interface 51 may both receive data signals through, and transmit data signals into/through the column of fluid in the BOP assembly 19. For example, running tool wireless interface 51 may first receive a data signal transmitted through the column of fluid in the BOP assembly 19 via the BOP assembly wireless interface 45 also in communication with the fluid in the BOP assembly 19. Running tool wireless interface 51 may then demodulate the received signal or provide the received signal to a separate controller, where the signal is processed. The interface 51 or controller may then, in turn, communicate with the various functions of running tool 23 in response to the instructions provided in the received signal. For example, the interface 51 or controller may signal hydraulic valve 59 to allow hydraulic pressure from hydraulic accumulators 57 to flow and operate a function of running tool 23. The interface 51 or controller 53 may also or alternatively receive signals from sensors 61. If the embodiment includes an intermediate controller, the controller may then process the sensor signals and transmit the sensor signals to running tool wireless interface 51. Regardless, the running tool wireless interface 51 transmits and/or modulates a signal including sensor data into the column of fluid in BOP assembly 19. The sensor data signals provided by the wireless interface 51 is received by/through BOP assembly wireless interface 45. In turn, BOP assembly wireless interface 45 may then pass the received signal or a data signal demodulated therefrom, to the appropriate equipment. Note, the controller can be part of the wireless interface 51 and/or an independent unit operably coupled to the wireless interface 51.

An operator located on platform 25 (FIG. 1), for example, may require operation of a hydraulic function of running tool 23. The operator may interact with DCP 29 (FIG. 1) to send a signal to CCU 27 (FIG. 1). CCU 27 may then send a signal to SEM 31 through electrical umbilical 33. There, SEM 31 can communicate the signal to BOP assembly wireless interface 45, where the signal may be converted, modulated and/or transmitted into the column of fluid within BOP assembly 19. The running tool wireless interface 51 may then receive and/or demodulate the signal and provide the signal to a controller or provide a control signal for operation of hydraulic valves 59, for example, for release of hydraulic pressure within hydraulic accumulators 57.

Similarly, during a mechanical operation of running tool 23, such as rotation of running tool 23 during the process of engaging a seal (not shown) between a casing hanger (not shown) and wellhead 13 (FIG. 1), one or more sensors 61 (e.g., an azimuth sensor) may transmit a signal corresponding to the amount of rotational movement of running tool 23 either directly to the wireless interface 51 or indirectly through a separate intermediate controller (not shown). The sensor signal is then processed, and a corresponding data signal is transmitted and/or modulated to provide processed or unprocessed sensor data to the wireless BOP assembly interface 45 via the fluid in the BOP assembly 19. The BOP assembly wireless interface 45 receives and/or demodulates the signal. The signal may then be processed and provided to the surface through SEM 31, electrical umbilical 33, and CCU 27, where it may then be displayed to an operator on DCP 29. The operator may then conduct an appropriate action in response. For example, if four rotations of running tool 23 at the subsea location are needed to perform the mechanical operation, the operator may add additional rotations at the surface to compensate for twisting of running string 21 that may have absorbed one of the rotations due to the length of running string 21 based on the information received from running tool 23.

In alternative embodiments, sensor or sensors 61 may generate a signal in response to successful completion of a hydraulic operation by running tool 23, and/or sensor readings indicating that a casing hanger seal was successfully set or damaged. If damaged, the operator can forego initiating a pressure test, potentially further damaging seal and/or casing hanger.

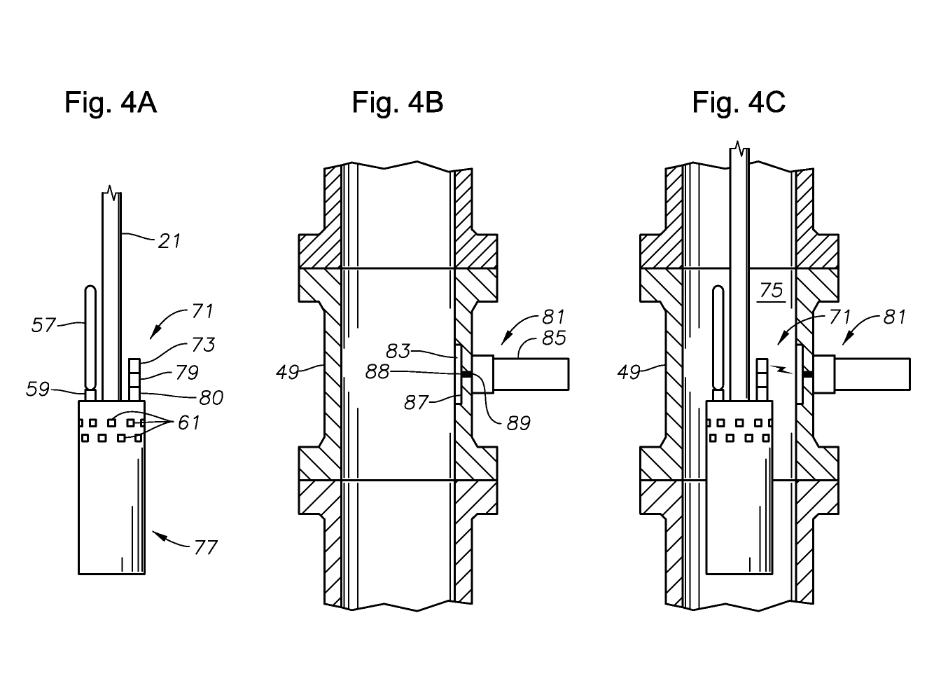

Referring to FIGS. 4A-7B, various wireless communication schemes and associated components are provided according to various embodiments of the present invention. For example, FIGS. 4A-4C illustrate an RF communications scheme. As shown in FIG. 4A, according to such embodiment, the running tool wireless interface 71 includes a radiofrequency (RF) antenna 73 positioned in contact with the fluid medium 75 surrounding the running tool 77, a controller-transceiver 79 operably coupled to the antenna 73 and to sensors 61, and a power supply 80. Controller-transceiver 79 can take the form of two separate devices, a controller in communication with a transmitter or combination transmitter and receiver, or a single controller-transmitter/transceiver device as understood by those of ordinary skill in the art providing communication functions and/or control functions when so configured.

The power supply 80 of the running tool wireless interface can include various types understood by those of ordinary skill in the art. Examples include a battery source having sufficient charge to provide electric potential to the electrically operated devices/functions, negating any need for an additional external power source. In an exemplary embodiment, this includes providing power for operation of running tool RF receiver/controller 71, sensors 61, and/or hydraulic valves 59. A person skilled in the art will understand that these functions and components may comprise integral components of running tool 23. A person skilled in the art will also understand that these functions and components may comprise a separate module coupled to running tool 23. A person skilled in the art will further understand that running tool 23 may include various combinations of the components described above, selected to perform a particular function within subsea wellhead 17.

Each operationally functional electrical component may be communicatively coupled with the controller-transceiver 79 to both receive signals from and transmit signals to controller-transceiver 79. For example, receiver/controller 79 may transmit signals to hydraulic valves 59, causing hydraulic valves 59 to open or close in response. Similarly, sensors 61 may transmit signals to controller-transceiver 79 that provide measurements of selected parameters at the running tool 23. In an embodiment, at least one of the sensors 61 may be an azimuth sensor that provides heading information processed by the controller to indicate the number of turns running tool 23 may have undergone in response to rotation of running string 21 at platform 25. Other sensors 61 may provide temperature, external/internal pressure, torque, axial position, tension, hydraulic function positive indicator, wellhead seal engagement pressure, and dog extension data, to the controller-transceiver 79.

FIG. 4B shows a complementary BOP assembly wireless interface 81 which includes an RF antenna 83 positioned in contact with the fluid medium 75 adjacent thereto, a controller-transceiver 85, and a power source (not shown). Controller-transceiver 85 can take the form of two separate devices, a controller in communication with a receiver or combination transmitter and receiver, or a single device, along with other forms. The RF antenna 83 is typically embedded flush within a recess 87 and is connected to the controller-transceiver 85 via a conductor 88 extending through a bore 89 extending radially through the tubular member 49.

FIG. 4C illustrates the running tool wireless interface 71 in RF communication with the BOP wireless interface 81 over/through the fluid medium 75 within the axial bore of the tubular member 49. According to an exemplary embodiment, the controller-transceiver 79 receives sensor data signals from one or more sensors 61. The controller-transceiver 79 can perform various functions with respect to sensor data to provide data indicating if the tool being run was successfully set and/or whether or not proper setting loads were imparted on. Such functions can include, but are not limited to, determining running tool angular position, determining running tool alignment with respect to the wellhead, determining running tool hydraulic operation status, determining running tool setting loads imparted on a wellhead seal, and determining proper running tool dog engagement.

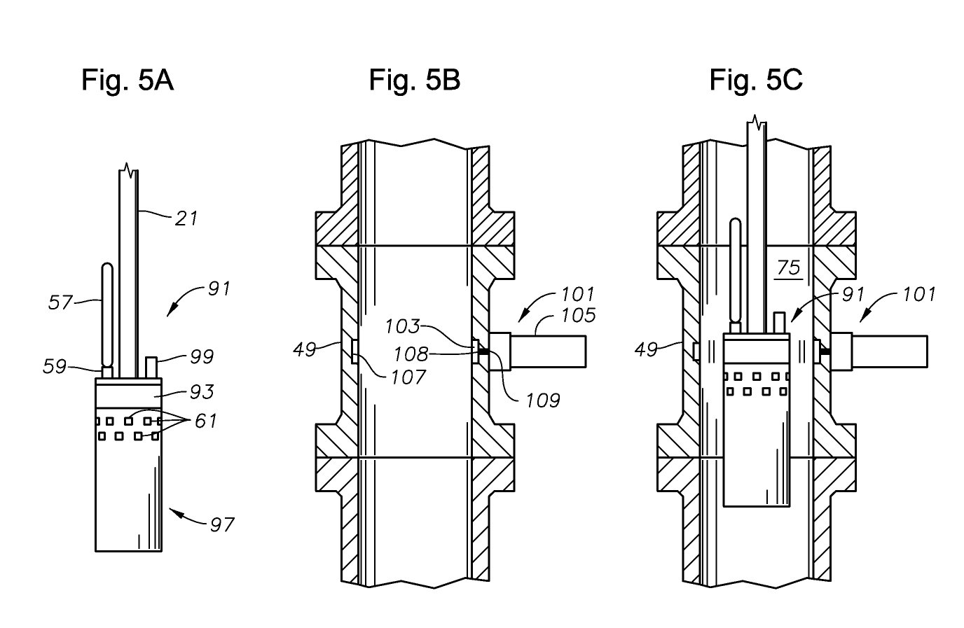

FIGS. 5A-5C illustrate an inductive coupling communications scheme. As shown in FIG. 5A, according to such embodiment, a running tool wireless interface 91 includes a running tool-mounted induction loop (i.e., antenna coil) 93 positioned in contact with the fluid medium 75 surrounding the running tool 97, and a controller 99 operably coupled to the induction loop 93. The controller 99 is also operably coupled to the sensors 61 to collect and process the tool engagement and other tool data as described, for example, with respect to the embodiment shown in FIG. 4A and/or to provide control signals to the sensors 61 and/or one or more running tool components. Note, although depicted as a complete loop extending around the circumference of the tool 97, induction loop 93 can be in the form of a more localized coil antenna or set of localized coil antennas.

FIG. 5B shows a BOP wireless interface 101 configured to receive and demodulate data provided through inductive coupling. Wireless interface 101 includes an induction loop 103 positioned in contact with the fluid medium 75 adjacent thereto, and a controller 105. The induction loop 103 is typically embedded flush within a recess 107 and is connected to the controller 105 via a conductor 108 extending through a bore 109, itself extending through the tubular member 49. Note, although depicted as a complete loop extending around the inner circumference of the tubular member 49, induction loop 103 can be in the form of one or more coil antennas positioned within recess 107 are within a plurality of separate recesses.

FIG. 5C illustrates the running tool wireless interface 91 in near field communications (inductive coupling) with the BOP wireless interface 101 over/through the fluid medium 75 within the axial bore of the tubular member 49. According to the exemplary embodiment, running tool wireless interface controller 99 “sends” its data by changing the load on the induction loop 93 which can be detected by the controller 105 of the BOP wireless interface 101.

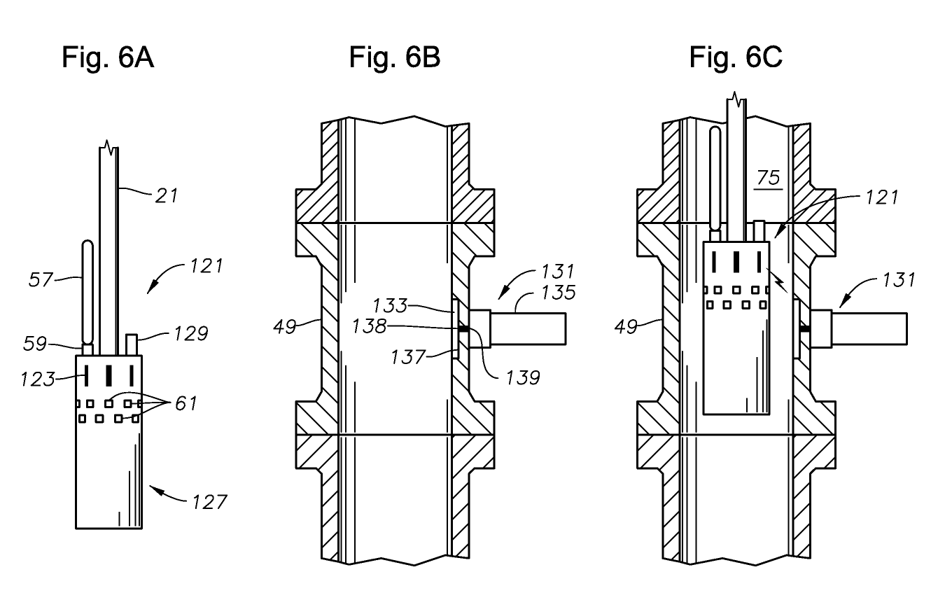

FIGS. 6A-6C illustrate a backscatter coupling communications scheme. As shown in FIG. 6A, according to such embodiment, a running tool wireless interface 121 includes one or more spaced apart antennae (e.g., coils) 123 positioned in contact with the fluid medium 75 surrounding the running tool 127, and a controller 129 operably coupled to the one or more antenna 123. The controller 129 is also operably coupled to the sensors 61 to collect and process the tool engagement and other tool data as described, for example, with respect to the embodiment shown in FIG. 4A and/or to provide control signals to the sensors 61 and/or one or more running tool components.

FIG. 6B shows a BOP wireless interface 131 configured to receive and demodulate data provided through backscatter coupling. The wireless interface 131 includes an antenna 133 positioned in contact with the fluid medium 75 adjacent thereto, and a controller 135. The antenna 133 is typically embedded flush within a recess 137 and is connected to the controller 135 via a conductor 138 extending through a bore 139, itself extending radially through the tubular member 49.

FIG. 6C illustrates the running tool wireless interface 121 in the far field communications (backscatter coupling) with the BOP wireless interface 131 over/through the fluid medium 75 within the axial bore of the tubular member 49. According to the exemplary embodiment, the running tool wireless interface 121 is passive in that it receives power from the radio waves emanating from the antenna 133, reflecting back a modulated form of the received signal, but modulated or otherwise carrying running tool engagement and/or other sensor data gathered from one or more sensors 61. Active embodiments are, however, within the scope of the present invention.

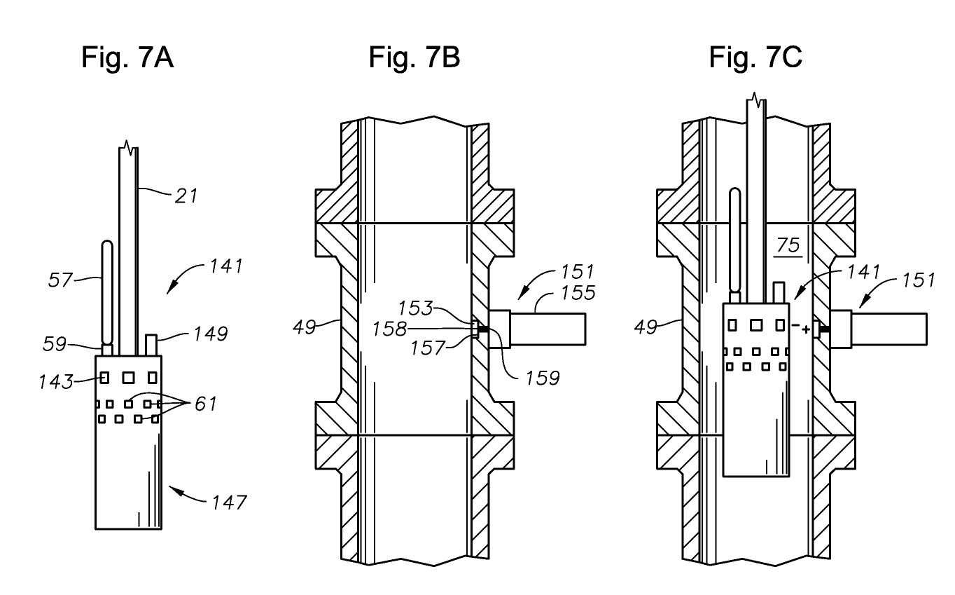

FIGS. 7A-7C illustrate a capacitive coupling communications scheme. As shown in FIG. 7A, according to such embodiment, a running tool wireless interface 141 includes one or more spaced apart electrodes 143 positioned in contact with the fluid medium 75 (dielectric medium) surrounding the running tool 147, and a controller 149 operably coupled to the one or more electrodes 143. The controller 149 is also operably coupled to the sensors 61 to collect and process the tool engagement and other tool data as described, for example, with respect to the embodiment shown in FIG. 4A and/or to provide control signals to the sensors 61 and/or one or more running tool components.

FIG. 7B shows a BOP wireless interface 151 configured to receive data provided through the capacitive coupling. Wireless interface 151 includes an electrode 153 positioned in contact with the fluid medium 75 adjacent thereto, and a controller 155 operably coupled thereto. The electrode 153 or electrodes is/are typically embedded flush within a recess 157 and is/are connected to the controller 155 via a conductor 158 extending through a bore 159, itself extending through the tubular member 49.

FIG. 7C illustrates the running tool wireless interface 141 in communications (capacitive coupling) with the BOP wireless interface 151 over/through the fluid medium 75 within the axial bore of the tubular member 49. According to the exemplary embodiment, the electrodes 143, 157 function as plates of a capacitor positioned on either side of a dielectric medium (i.e., fluid medium 75), to, in essence, form a capacitor through which sensor data signals can be passed.

Methods for communicating between a surface platform 25 and a subsea running tool 23 disposed within a subsea wellhead 17, a blowout preventer assembly 39, or a combination thereof, are also provided. An example of such a method can include the steps of providing a running tool wireless interface 51 carried by a running tool 23, providing a blowout preventer assembly wireless interface 45 mounted to a member 35, 43, 49 of a blowout preventer assembly 39 or mounted to a subsea wellhead 17 connected with the blowout preventer assembly 39, positioning the running tool 23 within an axial bore of one or more members of the blowout preventer assembly 39, and/or an axial bore of the subsea wellhead 17, and communicating running tool sensor data to the blowout preventer assembly wireless interface 45 through a fluid medium 75 located between the running tool wireless interface 51 and the blowout preventer assembly wireless interface 45.

The steps can also include providing the running tool 23 having one or more running tool sensors 61 positioned on the running tool 23. The running tool sensor or sensors 61 can include an azimuth sensor that provides a rotational azimuth of the running tool, a hydraulic function positive indicator sensor, a wellhead seal engagement pressure sensor, and/or a dog extension sensor. The steps can correspondingly include determining running tool angular position, determining running tool alignment with respect to the wellhead, determining running tool hydraulic operation status, determining running tool setting loads imparted on a wellhead seal, and/or determining proper running tool dog engagement.

According to another embodiment, the steps can include providing a running tool 23 having one or more running tool engagement sensors represented by 61 positioned on the running tool 23, determining the running tool's engagement status, and providing the running tool engagement data to the blowout preventer assembly wireless interface 45. The running tool engagement status can include running tool rotational position, running tool alignment with respect to the wellhead, running tool hydraulic operation status, running tool setting loads imparted on a wellhead seal, and/or running tool dog engagement status.

In a specific configuration, the running tool 23 has a hydraulic accumulator 57 mounted to the running tool 23 and at least one hydraulic valve 59 mounted to the running tool 23 to control fluid pressure between the hydraulic accumulator 57 and a hydraulic function of the running tool 23. In this configuration, the blowout preventer wireless interface 45 is communicatively coupled to a subsea electronics module 31 communicatively coupled to an umbilical 33 extending to a surface platform 25 (at central control unit 27), and the one or more tool engagement sensors represented at 61 includes a positive hydraulic function indicator sensor that provides data indicating operation of the hydraulic function of the running tool 23 to a running tool controller. In this configuration, the steps also include providing actuation commands to the at least one hydraulic valve 59 to provide hydraulic pressure to the hydraulic function of the running tool 23 responsive to control instructions provided by a platform operator and relayed through the subsea electronic module 31, blowout preventer wireless interface 45, and one or more components of the running tool wireless interface 51, to the running tool controller.

In another embodiment, the running tool assembly includes an azimuth sensor 61 that provides a rotational position of the running tool 23. In this embodiment, the step of communicating running tool sensor data to the blowout preventer assembly wireless interface 45 includes communicating the rotational position of the running tool 23 to the blowout preventer assembly wireless interface 45. Correspondingly, the steps can also include communicating the rotational position of the running tool 23 to a surface platform operator control or monitoring unit 29 through utilization of a subsea control module 31 communicatively coupled to an umbilical 33 extending to the central control unit 27 on the surface platform 27.

According to various embodiments, the running tool wireless interface 45 is configured to communicate the running tool sensor data to the blowout preventer wireless interface via RF communications through the fluid medium 75 between antenna components thereof, mutual inductive coupling, backscatter coupling, and capacitive coupling.

When configured for RF communications, a running tool wireless interface 71 can include a running tool-mounted radiofrequency (RF) antenna 73 positioned in contact with the fluid medium 75 surrounding the running tool 23 and the blowout preventer assembly wireless interface 81 can include a blowout preventer member-mounted RF antenna 83 positioned in contact with the fluid medium 75 adjacent thereto. In such configuration, the step of communicating running tool sensor data can include transmitting a data signal between the running tool-mounted RF antenna 73 and the blowout preventer assembly member-mounted RF antenna 83 through the fluid medium 75 located therebetween.

When configured for near-field or inductive coupling communication, a running tool wireless interface 91 can include a running tool-mounted induction loop 93 positioned in contact with the fluid medium 75 surrounding the running tool 23 and the blowout preventer assembly wireless interface 101 can include a blowout preventer assembly member-mounted induction loop 103 positioned in contact with the fluid medium 75 adjacent thereto. In such configuration, the step of communicating running tool sensor data can include positioning the running tool 97 so that the running tool-mounted induction loop 93 is axially positioned adjacent the blowout preventer assembly member-mounted induction loop 103, and inductively coupling the blowout preventer assembly member-mounted induction loop 103 with the running tool-mounted induction loop 93 when the running tool-mounted induction loop 93 is axially adjacent the blowout preventer assembly member-mounted induction loop 103 to provide the running tool sensor data to the blowout preventer assembly wireless interface 101.

When configured for far-field (or backscatter) coupling communication, the running tool wireless interface 121 can include a running tool-mounted antenna or antennae 123 positioned in contact with the fluid medium 75 surrounding the running tool 127 and the blowout preventer assembly wireless interface 131 can include a blowout preventer assembly member-mounted antenna 133 or antennae positioned in contact with the fluid medium 75 adjacent thereto. In such configuration, the step of communicating running tool sensor data can include reflecting, by the running tool wireless interface 121, a signal provided by the blowout preventer assembly wireless interface 131 performed through the fluid medium 75 between the running tool-mounted antenna or antennae 123 and the blowout preventer assembly member-mounted antenna 133 or antennae.

When configured for capacitive coupling communication, the running tool wireless interface 141 can include a running tool-mounted electrode or electrodes 143 positioned in contact with the fluid medium 75 surrounding the running tool 147 and the blowout preventer assembly wireless interface 151 can include a blowout preventer assembly member-mounted electrode 153 or electrodes positioned in contact with the fluid medium 75 adjacent thereto. In such configuration, the step of communicating running tool sensor data can include positioning the running tool 147 so that at least one of the running tool-mounted electrodes 143 is axially positioned adjacent the blowout preventer assembly member-mounted electrode 153, and capacitively coupling the blowout preventer-mounted electrode 153 with the respective running tool-mounted electrode 143 when the running tool-mounted electrode 143 is axially adjacent the blowout preventer-mounted electrode 153, forming an electric field therebetween to provide the running tool sensor data to the blowout preventer assembly wireless interface 151 through the fluid medium 75 between the respective electrodes 143, 153.

The disclosed embodiments provide numerous advantages. For example, the disclosed embodiments provide a system for wireless communication between a running tool located subsea and an operator located on a sea surface. This allows communication of instructions downhole to the running tool for operation of hydraulic functions without the need for a hydraulic or electric umbilical. In addition, the system provides a means to communicate information from the subsea location to the surface with sufficient speed to allow the operator to adjust running tool operations/positioning at the surface to account for conditions at the subsea location. Still further, the communication system employs existing umbilicals and subsea electronics modules to operate and/or monitor the functions of the running tool. This allows operators to gain additional functionality out of these apparatuses that are typically only used to control the subsea BOP. As disclosed herein, the existing umbilicals and subsea electronics modules can be used to operate the subsea BOP, and a subsea running tool disposed within and adjacent the BOP assembly.

Various embodiments of the present invention advantageously employ an RF, inductive (near field), backscatter (far field), and/or capacitive communications scheme or schemes to provide data from running tools that run in/through the bore of the BOP or adjacent members, to the BOP communication system. According to various embodiments of the present invention, the running tool is equipped with technology to transmit or otherwise transfer the data either via an RF or RF-backscatter signal that goes across the space between running tool and BOP or with an inductive or capacitive type coupler, to span the gap. The gap between tool and BOP or other tubular member is generally filled with mud or fluid. Correspondingly, the BOP or adjacent components of the BOP assembly can include the communication interface (e.g., RF antenna, induction loop/antenna, electrodes, etc.) to receive the data from the tool. The BOP communication system can then communicate the data to the surface via the subsea-surface communication network.

According to various embodiments of the present invention, the running tool can advantageously incorporate sensors to detect desired data, such as, for example, data indicating if the tool being run was successfully set and/or whether or not proper setting loads were imparted on hanger seals. If not, then the well owner can be informed that he/she should forgo pressure testing, saving time and money. If the running tool is one that is configured to reset the seal, then the running tool can be instructed to perform such tasks, negating the need for a separate trip in and out of the well hole, saving additional time and money. With the combination of sensors on the running tool recording real-time tool conditions, and the above described subsea communications technology, the rig operator can advantageously receive virtually instant feedback on the success of the running operation. Currently, the rig operator has to pull the string and inspect the lead indicators on the running tool, which can take hours and cost thousands of dollars, just to determine what has happened or whether or not a malfunction has occurred. The quicker feedback can enable the rig operator to more expeditiously respond to the success or failure, saving time and money.

This application is a continuation-in-part of and claims priority to and the benefit of U.S. patent Ser. No. 13/248,813, filed on Sep. 29, 2011, incorporated by reference in its entirety.

In the drawings and specification, there have been disclosed a typical preferred embodiment or embodiments of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification. For example, the disclosed embodiments have been discussed primarily with respect to subsea drilling operations. A person skilled in the art will understand that the disclosed embodiments may also be used with production operations. Such embodiments are contemplated and included in the embodiments disclosed herein. In addition, the disclosed embodiments may provide positive confirmation of performance of an operation by the subsea running tool. Also, for example, although the running tool was described as having an antenna/induction coil in communication with a corresponding antenna/induction coil connected to a portion of the BOP, connection to other portions of the subsea equipment is within the scope of one or more embodiments of the present invention. Additionally, one or more embodiments of the present invention can provide for employment of a direct contact between a communication components of the running tool and corresponding communication components of the BOP assembly and/or inner surface portions of a member of the BOP assembly to form a contact-based communication circuit to provide for data communications therebetween. Data could then be transmitted acoustically, electronically, electrically, or inductively through the solid connection between the running tool and the BOP.

That claimed is:

1. A running tool communication system for communicating between a surface platform and a subsea running tool disposed within a subsea wellhead, a blowout preventer assembly, or a combination thereof, the running tool communication system comprising a running tool assembly, the running tool assembly comprising:
a running tool adapted to be suspended within a subsea wellhead, a blowout preventer assembly, or a combination thereof, on or by a running string lowered from a surface platform; and
a running tool wireless interface carried by the running tool and configured to communicate with a blowout preventer assembly wireless interface through a fluid medium located between the running tool wireless interface and the blowout preventer assembly wireless interface when the running tool is operably positioned within an axial bore extending through a member of the blowout preventer assembly or an axial bore extending through the subsea wellhead and when the running tool wireless interface is at a location within communication range with the blowout preventer assembly wireless interface to thereby provide running tool sensor data to the blowout preventer assembly wireless interface.

2. A running tool communication system as defined in claim 1, further comprising:
the blowout preventer assembly disposed on the subsea wellhead;
wherein the blowout preventer assembly is in communication with a subsea electronics module; and
wherein the blowout preventer assembly includes the blowout preventer assembly wireless interface, the blowout preventer assembly wireless interface configured to provide the running tool sensor data to the subsea electronics module.

3. A running tool communication system as defined in claim 1,
wherein the running tool wireless interface comprises a radiofrequency (RF) antenna positioned in contact with the fluid medium surrounding the running tool;
wherein the blowout preventer assembly wireless interface comprises an RF antenna positioned in contact with the fluid medium adjacent thereto;
wherein the running tool wireless interface is configured to communicate sensor data to the blowout preventer wireless interface via RF communications through the fluid medium.

4. A running tool communication system as defined in claim 1,
wherein the running tool wireless interface comprises a running tool-mounted induction loop positioned in contact with the fluid medium surrounding the running tool; and
wherein the blowout preventer assembly wireless interface comprises a blowout preventer-mounted induction loop in contact with the fluid medium adjacent thereto; and
wherein the running tool wireless interface is configured to inductively couple with the running tool-mounted induction loop when the running tool is operably positioned within the bore extending through a member of the blowout preventer assembly or the bore extending through the subsea wellhead and when the running tool-mounted induction loop is axially positioned adjacent the blowout preventer-mounted induction loop to transfer data to the blowout preventer wireless interface.

5. A running tool communication system as defined in claim 1,
wherein the running tool wireless interface comprises an antenna positioned in contact with the fluid medium surrounding the running tool;
wherein the blowout preventer assembly wireless interface comprises an antenna positioned in contact with the fluid medium adjacent thereto; and
wherein the running tool wireless interface is configured to provide for backscatter coupling with the blowout preventer assembly wireless interface to thereby communicate sensor data through the fluid medium to the blowout preventer wireless interface.

6. A running tool communication system as defined in claim 1,
wherein the running tool wireless interface comprises an electrode positioned in contact with the fluid medium surrounding the running tool;
wherein the blowout preventer assembly wireless interface comprises an electrode positioned in contact with the fluid medium adjacent thereto;
wherein the running tool wireless interface is configured to capacitively couple with the blowout preventer assembly wireless interface for the running tool is operably positioned within the bore extending through a member of the blowout preventer assembly or the bore extending through the subsea wellhead and the running tool electrode is axially positioned adjacent the blowout preventer electrode.

7. A running tool communication system as defined in claim 1, wherein the running tool assembly further comprises:
one or more running tool sensors, the one or more running tool engagement sensors comprising one or more of the following: an azimuth sensor that provides a rotational azimuth of the running tool, a hydraulic function positive indicator sensor, a wellhead seal engagement pressure sensor, and a dog extension sensor; and
a running tool controller operably coupled to the one or more tool sensors and configured to perform one or more of the following operations: determining running tool angular position, determining running tool alignment with respect to the wellhead, determining running tool hydraulic operation status, determining running tool setting loads imparted on a wellhead seal, and determining proper running tool dog engagement, individually or collectively defining the running tool engagement data.

8. A running tool communication system as defined in claim 1, wherein the running tool assembly further comprises:
one or more running tool engagement sensors; and
a running tool controller operably coupled to the one or more tool engagement sensors, the running tool controller configured to determine running tool engagement status, the running tool engagement status including one or more of the following: running tool rotational position, running tool alignment with respect to the wellhead, running tool hydraulic operation status, running tool setting loads imparted on a wellhead seal, and running tool dog engagement status, individually or collectively defining the running tool engagement data; and
wherein the running tool wireless interface is operably coupled to the running tool controller to receive the running tool engagement data from the running tool controller to thereby provide the running tool engagement data to the blowout preventer assembly wireless interface.

9. A running tool communication system as defined in claim 8, wherein the running tool assembly further comprises:
a hydraulic accumulator mounted to the running tool; and
at least one hydraulic valve mounted to the running tool to control fluid pressure between the hydraulic accumulator and a hydraulic function of the running tool;
wherein the running tool controller is further configured to provide actuation commands to the at least one hydraulic valve to provide hydraulic pressure to the hydraulic function of the running tool; and
wherein the one or more tool engagement sensors comprise a positive indicator sensor that provides a signal or data indicating operation of the hydraulic function of the running tool to the running tool controller.

10. A running tool communication system as defined in claim 1, further comprising:
the blowout preventer assembly disposed on the subsea wellhead;
wherein the blowout preventer assembly is in communication with a subsea electronics module;
wherein the blowout preventer assembly includes the blowout preventer assembly wireless interface, the blowout preventer assembly wireless interface configured to provide the running tool sensor data to the subsea electronics module;
wherein the running tool assembly further comprises an azimuth sensor that provides a rotational position of the running tool;
wherein the subsea electronic module is communicatively coupled to an umbilical extending to the surface platform and configured to relay the running tool sensor data to a central control unit and to relay control instructions to the running tool;
wherein the running tool communication system further comprises a central control unit positioned on the surface platform and in communication with the subsea electronics module, the central control unit configured to receive the running tool sensor data and to provide control instructions to the running tool.

11. A running tool subsea communication system for communicating between a surface platform and a subsea running tool disposed within a subsea wellhead, a blowout preventer assembly, or a combination thereof, the running tool communication system comprising a running tool assembly, the system comprising:
a blowout preventer assembly disposed on a subsea wellhead;
a blowout preventer assembly wireless interface carried by one or more members of the blowout preventer assembly and configured to provide running tool sensor data to a subsea electronics module;
a running tool adapted to be suspended within the subsea wellhead, the one or more members of the blowout preventer assembly, or a combination thereof, on or by a running string lowered from a surface platform; and
a running tool wireless interface carried by the running tool and configured to communicate with the blowout preventer assembly wireless interface through a fluid medium located between the running tool wireless interface and the blowout preventer assembly wireless interface when the running tool is operably positioned within an axial bore extending through a member of the blowout preventer assembly or an axial bore extending through the subsea wellhead and when the running tool wireless interface is at a location within communication range with the blowout preventer assembly wireless interface to thereby provide running tool sensor data to the subsea electronics module,
the running tool wireless interface configured to communicate the running tool sensor data to the blowout preventer wireless interface via one or more of the following communication schemes: RF communications through the fluid medium between antenna components thereof, mutual inductive coupling, backscatter coupling, and capacitive coupling.

12. A method for communicating between a subsea running tool disposed within a subsea wellhead, a blowout preventer assembly, or a combination thereof, and a surface platform, the method comprising the steps of:
providing a running tool wireless interface carried by a running tool;
providing a blowout preventer assembly wireless interface mounted to a member of a blowout preventer assembly or mounted to a subsea wellhead connected with the blowout preventer assembly;
positioning the running tool within an axial bore of one or more members of the blowout preventer assembly, an axial bore of the subsea wellhead, or a combination thereof; and
communicating running tool sensor data to the blowout preventer assembly wireless interface through a fluid medium located between the running tool wireless interface and the blowout preventer assembly wireless interface.

13. A method as defined in claim 12, wherein the running tool wireless interface comprises a running tool-mounted radiofrequency (RF) antenna positioned in contact with the fluid medium surrounding the running tool, wherein the blowout preventer assembly wireless interface comprises a blowout preventer member-mounted RF antenna positioned in contact with the fluid medium adjacent thereto, and wherein the step of communicating running tool sensor data includes:
transmitting a data signal between the running tool-mounted RF antenna and the blowout preventer assembly member-mounted RF antenna through the fluid medium located therebetween.

14. A method as defined in claim 12, wherein the running tool wireless interface comprises a running tool-mounted induction loop positioned in contact with the fluid medium surrounding the running tool, wherein the blowout preventer assembly wireless interface comprises a blowout preventer assembly member-mounted induction loop positioned in contact with the fluid medium adjacent thereto, and wherein the step of communicating running tool sensor data includes the step of:
positioning the running tool so that the running tool-mounted induction loop is axially positioned adjacent the blowout preventer assembly member-mounted induction loop; and
inductively coupling the blowout preventer assembly member-mounted induction loop with the running tool-mounted induction loop when the running tool-mounted induction loop is axially adjacent the blowout preventer assembly member-mounted induction loop to provide the running tool sensor data to the blowout preventer assembly wireless interface.

15. A method as defined in claim 12, wherein the running tool wireless interface comprises a running tool-mounted antenna positioned in contact with the fluid medium surrounding the running tool, and wherein the blowout preventer assembly wireless interface comprises a blowout preventer assembly member-mounted antenna positioned in contact with the fluid medium adjacent thereto, and wherein the step of communicating running tool sensor data includes the step of:
reflecting, by the running tool wireless interface, a signal provided by the blowout preventer assembly wireless interface defining backscatter coupling performed through the fluid medium between the running tool-mounted antenna and the blowout preventer assembly member-mounted antenna.

16. A method as defined in claim 12, wherein the running tool wireless interface comprises a running tool-mounted electrode positioned in contact with the fluid medium surrounding the running tool, wherein the blowout preventer assembly wireless interface comprises a blowout preventer assembly member-mounted electrode positioned in contact with the fluid medium adjacent thereto, and wherein the step of communicating running tool sensor data includes the steps of:
positioning the running tool so that the running tool-mounted electrode is axially positioned adjacent the blowout preventer assembly member-mounted electrode; and
capacitively coupling the blowout preventer-mounted electrode with the running tool-mounted electrode when the running tool-mounted electrode is axially adjacent the blowout preventer-mounted electrode, forming an electric field therebetween to provide the running tool sensor data to the blowout preventer assembly wireless interface through the fluid medium between the respective electrodes.

17. A method as defined in claim 1, further comprising the step of:
providing the running tool having one or more running tool sensors positioned on the running tool, the one or more running tool sensors comprising one or more of the following: an azimuth sensor that provides a rotational azimuth of the running tool, a hydraulic function positive indicator sensor, a wellhead seal engagement pressure sensor, and a dog extension sensor.

18. A method as defined in claim 17, further comprising performing one or more of the following:
determining running tool angular position;
determining running tool alignment with respect to the wellhead;
determining running tool hydraulic operation status;
determining running tool setting loads imparted on a wellhead seal; and
determining proper running tool dog engagement.

19. A method as defined in claim 12, further comprising the steps of:
providing the running tool having one or more running tool engagement sensors positioned on the running tool;
determining running tool engagement status, the running tool engagement status including one or more of the following—running tool rotational position, running tool alignment with respect to the wellhead, running tool hydraulic operation status, running tool setting loads imparted on a wellhead seal, and running tool dog engagement status; and
providing the running tool engagement status to the blowout preventer assembly wireless interface.

20. A method as defined in claim 19, wherein the running tool comprises a hydraulic accumulator mounted to the running tool and at least one hydraulic valve mounted to the running tool to control fluid pressure between the hydraulic accumulator and a hydraulic function of the running tool, wherein the blowout preventer wireless interface is communicatively coupled to a subsea electronics module communicatively coupled to an umbilical extending to a surface platform, and wherein the one or more tool engagement sensors comprise a positive hydraulic function indicator sensor that provides data indicating operation of the hydraulic function of the running tool to a running tool controller, the method further comprising the step of:
providing actuation commands to the at least one hydraulic valve to provide hydraulic pressure to the hydraulic function of the running tool responsive to control instructions provided by a platform operator and relayed through the subsea electronic module, blowout preventer wireless interface, and one or more components of the running tool wireless interface, to the running tool controller.

21. A method as defined in claim 12, wherein the running tool assembly further comprises an azimuth sensor that provides a rotational position of the running tool, and wherein the step of communicating running tool sensor data to the blowout preventer assembly wireless interface includes communicating the rotational position of the running tool to the blowout preventer assembly wireless interface, the method further comprising the step of:
communicating the rotational position of the running tool to a surface platform operator control or monitoring unit, the communication performed through a subsea control module communicatively coupled to an umbilical extending to the surface platform.
